(19) United States
(12) Patent Application Publication
(10) Pub. No.: US 2020/0271606 A1
(43) Pub. Date: Aug. 27, 2020

(54) VERTICAL CHEMIRESISTOR GAS SENSOR

(71) Applicant: Sumitonmo Chemical Company Limied, Tokyo (JP)

(72) Inventors: Daniel Tobjork, Cambridgeshire (GB); Richard J. Wilson, Cambridge (GB)

(73) Assignee: Sumitonmo Chemical Company Limied, Tolyo (JP)

(21) Appl. No.: 16/651,281

(22) PCT Filed: Sep. 24, 2018
(86) PCT No.: PCT/EP2018/075810

§ 371 Date: Mar. 26, 2020

(30) Foreign Application Priority Data
Sep. 29, 2017 (GB) 1715847.8
Nov. 21, 2017 (GB) 1719329.3

(51) Int. Cl. G01N 27/12; G01N 27/414

(52) U.S. Cl. CPC G01N 27/126; G01N 27/4141

(57) ABSTRACT

A sensor for detecting and measuring a gas in a gaseous environment where the gaseous environment contains an interferent such as a related gas. A vertical chemiresistor with a top gate includes a semiconductor layer that has a bulk resistivity that changes in the presence of the gas and/or the interferent. The electrodes (103, 107) of the vertical chemiresistor have a work function that changes when the gas is absorbed onto the electrode. This absorption changes the work function of the electrode and thereby the contact resistance of the electrode in the vertical chemiresistor. By detecting changes in the contact resistance and the bulk resistivity of the semiconducting layer (105) the presence and the concentration of the gas may be determined and distinguished from the interferent.

### FIELD

Embodiments of the present disclosure relate to a vertical chemiresistor for detection of gases in an environment, and particularly, but not by way of limitation, to differentiating between gases in the environment.

### BACKGROUND

Ethylene produced by plants can accelerate ripening of climacteric fruit, the opening of flowers, and the shedding of plant leaves. 1-methylcyclopropene (1-MCP) is known for use in inhibiting such processes.

US 2015/0247832A1 discloses a sensor having a conductive region including a conductive material and an alkene-interacting metal complex.

WO 2016/010855 discloses a sensor device having first and second electrodes in electrical contact with a paste including conductive carbonaceous nanomaterial particles, a detector capable of interaction with an analyte of interest and an ionic liquid.

Chuang et al, “Modulated gas sensor based on vertical organic diode with blended channel for ppb-regime detection”, Sensors and Actuators B: Chemical Volume 230, July 2016, Pages 223-230, discloses an ammonia gas sensor based on a vertical organic diode using phenyl-C61-butyric acid methyl ester (PCBM) as the sensing layer.

Matic et al, Sensors (Basel). 2015 Nov.; 15(11): 28088-28098. discloses ethylene measurements with MOx chemiresistive sensors.

Dai et al, Sensors (Basel). 2014 Sep. 2; 14(9):16287-95, discloses an ammonia sensor of a diode containing poly(3-hexylthiophene) (P3HT) or poly(5,5′-bis(3-dodecyl-2-thienyl)-2,2′-bithiophene) (PQT-12) with a vertical channel and a porous top electrode.

It is an object of the invention to provide a gas sensor capable of detecting alkenes.

It is a further object of the invention to provide a gas sensor capable of distinguishing between different gases, in particular different alkenes.

### SUMMARY

The present inventors have found that a vertical chemiresistor with a top gate/contact may be used to detect the presence and/or concentration of a gas in a gaseous environment. Even though the vertical chemiresistor includes a top gate/contact, the gas interacts with the top/gate/contact and/or a semiconductor layer of the vertical chemiresistor.

In embodiments of the present disclosure, the top or bottom gate of the vertical chemiresistor is configured such that a work function of the top or bottom gate is changed by a gas to be sensed. This change in the work function of the top and/or bottom gate changes the contact resistivity of the vertical chemiresistor. By contrast, the work function of the top or bottom gate is not changed by a second gas that may be found in a sensing environment. The vertical chemiresistor further comprises a semiconducting layer configured to have a bulk resistance that changes when contacted with the second gas. In embodiments of the present disclosure, by applying a potential difference across the vertical chemiresistor and measuring a current changes in the contact resistance and the bulk resistance can be determined. The changes in the contact resistance and the bulk resistance may be used to determine: a presence of the first gas; a presence of the second gas; a concentration of the first gas; and a concentration of the second gas. In embodiments of the present disclosure, the detection and/or measurement of the first gas may be performed in the presence of the second gas, even where both the first and the second gas change the bulk resistivity of the semiconductor layer of the vertical chemiresistor. In this way, the vertical chemiresistor gas sensor of the present disclosure may differentiate between and measure related gases or the like that are both present in an environment.

In some embodiments, a gas sensor configured for detecting and/or measuring a first gas in an environment containing a second gas. The gas sensor comprises a first vertical chemiresistor comprising a bottom electrode supported on a substrate, a top electrode and a semiconducting layer disposed between the bottom and top electrodes, wherein the bottom electrode and semiconducting layer are positioned between the top electrode and the substrate. A potential difference controller is configured to apply a first potential difference and a second potential difference to the first vertical chemiresistor. The polarity of the first potential difference is opposite to that of the second potential difference. The application of the different polarity potentials provides for determining differences in changes to the contact/electrode resistance and the bulk resistance of the semiconductor layer.

In some embodiments, a processor is configured to process a presence and/or a concentration of the first gas from a current measurement when the first potential difference is applied and a second current measurement when the second potential difference is applied to the first vertical chemiresistor.

In some embodiments, the semiconducting layer is an organic semiconducting layer. In some embodiments, the first and second gases comprise an alkene, such as 1-methylcyclopropene, ethylene and/or the like.

In some embodiments, at least one of the bottom and top electrodes is configured to provide that a work function of the at least one of the bottom and top electrodes changes when contacted by the first gas. In some embodiments, the contact resistance of the at least one of the bottom and top electrodes does not change when contacted by the second gas.

In some embodiments, a bulk resistance of the semiconductor layer changes when the semiconductor layer is contact with the first gas and/or the second gas. In some embodiments, at least one of the bottom and top electrodes comprises or consists of gold. In some embodiments, the first vertical chemiresistor comprises a blocking layer between at least one of the bottom and top electrodes and the organic semiconducting layer.

In some embodiments, a method is provided of using a vertical chemiresistor for detecting a first gas in an environment containing a second gas. In the method a first response of a first vertical chemiresistor to the gaseous environment is measured. From the first response the presence of the first gas is determined. The first vertical chemiresistor comprises a bottom electrode supported on a substrate, a top electrode and a semiconducting layer disposed between the top and bottom electrodes, and wherein at least one of the top and bottom electrodes comprises a material with a work function that changes when contacted with the first gas and is unchanged when contacted with the second gas.

In a first aspect the invention provides a method of detecting at least one alkene in a gaseous environment comprising measuring a response of a first vertical chemiresistor to the gaseous environment and determining from the response if the alkene is present, wherein the first vertical chemiresistor comprises a first electrode supported on a substrate, a second electrode and a semiconducting layer between the first and second electrodes and wherein the first electrode and semiconducting layer are between the second electrode and the substrate.

In a second aspect, the invention provides a method of detecting gas in an environment comprising measuring a response of a first vertical chemiresistor to the gaseous environment and determining from the response if the gas is present, wherein the first vertical chemiresistor comprises a first electrode supported on a substrate, a second electrode and a semiconducting layer between the first and second electrodes, wherein the first electrode and semiconducting layer are between the second electrode and the substrate and wherein an effective work function of the first and second electrodes is the same.

In a third aspect the invention provides a method of detecting gas in an environment comprising measuring a response of a first vertical chemiresistor to the gaseous environment and determining from the response if the gas is present, wherein the first vertical chemiresistor comprises a first electrode supported on a substrate, a second electrode and a semiconducting layer between the first and second electrodes, wherein the first electrode and semiconducting layer are between the second electrode and the substrate and wherein a surface of the first electrode facing the semiconducting layer and a surface of the second electrode facing the semiconducting layer comprise the same material.

A vertical chemiresistor may be integrated with another sensor. In use as a sensor, the responses of individual sensors of the integrated sensor may provide more information relating to presence and/or concentration of an analyte, such as a gas in a gaseous atmosphere, than an individual vertical chemiresistor.

Accordingly, in a fourth aspect the invention provides an integrated sensor comprising a vertical chemiresistor comprising a first electrode supported on a substrate, a second electrode and a semiconducting layer between the first and second electrodes and wherein the first electrode and semiconducting layer are between the second electrode and the substrate wherein one or more of the first electrode, second electrode and semiconducting layer is common to a further sensor of the integrated sensor.

### DESCRIPTION OF THE DRAWINGS

The invention will now be described in detail with reference to the Figures in which:

FIG. 1 illustrates a vertical chemiresistor for use as a gas sensor according to an embodiment in which first and second electrodes of the chemiresistor are in direct contact with a semiconductor layer;

FIG. 2 illustrates a vertical chemiresistor for use as a gas sensor according to an embodiment in which a bottom electrode has a blocking layer on a surface thereof;

FIG. 3 illustrates an integrated vertical chemiresistor and thin-film transistor;

FIG. 4 illustrates an integrated vertical chemiresistor and horizontal chemiresistor;

FIG. 5 illustrates a gas sensor system according to an embodiment;

FIG. 6A is a graph of current vs voltage upon exposure to 1-MCP of a vertical chemiresistor according to an embodiment without a thiol blocking layer;

FIG. 6B is a graph of current vs voltage upon exposure to 1-MCP of a vertical chemiresistor according to an embodiment with a thiol blocking layer;

FIG. 7A is a graph of change in current upon exposure tol-MCP of the vertical chemiresistor of FIG. 6A;

FIG. 7B is a graph of change in current upon exposure tol-MCP of the vertical chemiresistor of FIG. 6B;

FIG. 8 is a graph of change in current over time following exposure of a vertical chemiresistor according to an embodiment to 1-MCP; and

FIG. 9 is a graph of change in resistance over time following exposure of a vertical chemiresistor according to an embodiment to 1-MCP.

### DETAILED DESCRIPTION

The ensuing description above provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention, it being understood that various changes may be made in the function and arrangement of elements, including combinations of features from different embodiments, without departing from the scope of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, electromagnetic, or a combination thereof. Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while some aspect of the technology may be recited as a computer-readable medium claim, other aspects may likewise be embodied as a computer-readable medium claim, or in other forms, such as being embodied in a means-plus-function claim.

In the description above, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

The techniques introduced herein can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. The machine-readable medium includes non-transitory medium, where non-transitory excludes propagation signals. For example, a processor can be connected to a non-transitory computer-readable medium that stores instructions for executing instructions by the processor.

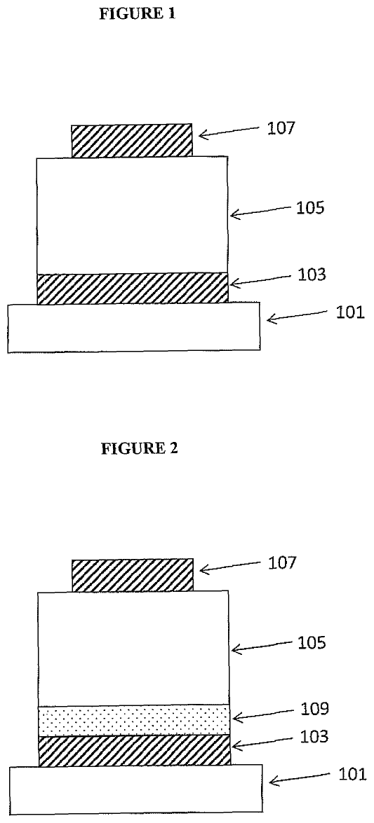

FIG. 1, which is not drawn to any scale, is a schematic illustration of a vertical chemiresistor gas sensor 100 according to an embodiment of the invention.

The vertical chemiresistor comprises a first, or bottom, electrode 103 supported on a substrate 101, a second, or top, electrode 107 and a semiconductor layer 105 between the first and second electrodes. It will be appreciated that the second electrode of the “vertical” arrangement described herein is spaced apart from the substrate by at least the first electrode and the semiconducting layer.

Substrate 101 may be formed from any suitable material including, without limitation, glass and plastic. The substrate may consist of a single layer or may comprise two or more layers supporting the first and second electrodes.

A layer “between” two other layers as described herein may be in direct contact with each of the two layers it is between or may be spaced apart from one or both of the two other layers by one or more intervening layers.

The first and second electrodes may be selected from a wide range of conducting materials for example a metal (e.g. gold), metal alloy, metal compound (e.g. indium tin oxide), conductive polymer or conducting carbon, e.g. carbon nanotube, graphite or graphene. The first and second electrodes may be the same or different. First and second electrodes may have same or different effective work functions.

“Effective work function” as used herein means the work function of the electrode at the surface of the electrode facing the organic semiconducting layer.

It will be appreciated that if the effective work functions of the first and second electrodes are the same or similar, for example within about 0.05 eV of each other, then the response of the chemiresistor at both forward and reverse bias is similar or the same. If the effective work functions are significantly different then diode-like behavior of the chemiresistor may be observed, with significant differences in behavior under forward and reverse bias.

Optionally, the electrode material at a surface of an electrode facing the semiconducting layer is the same material for the first and second electrodes.

Optionally, the second electrode does not completely cover the area of the semiconducting layer surface that it is deposited over. This may enhance absorption of gas into semiconducting layer 105. Optionally, the surface area of the second electrode is less than that of the first electrode.

As used herein, by a material “over” a layer is meant that the material is in direct contact with the layer or is spaced apart therefrom by one or more intervening layers.

As used herein, by a material “on” a layer is meant that the material is in direct contact with that layer.

The semiconducting layer preferably has a thickness of 20nm-10 microns, more preferably 100-500 nm. Preferably, the semiconducting layer has a thickness of at least 100 nm.

The semiconducting layer is preferably an organic semiconducting layer comprising or consisting of an organic semiconducting material. Vertical chemiresistors having an organic semiconducting layer are described hereinafter, however it will be understood that an inorganic semiconducting layer may be used.

In operation, the gas sensor is placed in a gaseous environment and the response of the sensor to the environment is measured. Gas in the environment may be absorbed into the organic semiconducting layer 105 and/or may bind covalently or non-covalently to the first and/or second electrode. Apparatus for measuring a response of the gas sensor in the environment may be used to determine if a particular gas is present in the environment. Preferably, the sensor is used in an environment in which one or both of ethylene and 1-methylcyclopropene may be present.

The first and second electrodes of a vertical chemiresistor as described herein may be in direct contact with the semiconducting layer, for example as illustrated in FIG. 1. In other embodiments, there may be at least one intervening layer between the first electrode and the semiconducting layer and/or the second electrode and the semiconducting layer.

FIG. 2 illustrates a device as described with reference to FIG. 1 except that blocking layer 109 is provided between the first electrode and the organic semiconducting layer. In other embodiments, the blocking layer may be provided between the second electrode and the organic semiconducting layer. The blocking layer is preferably the only layer between the first electrode and the organic semiconducting layer. The blocking layer 109 may partially or completely prevent an atmospheric gas from binding to the surface of the first electrode on which the blocking layer has been formed, thereby changing the response of the device to such a gas compared to a device in which the blocking layer 109 is not present.

In other embodiments (not shown), a blocking layer may be provided between the organic semiconducting layer and the second electrode. A blocking layer may be provided between the organic semiconducting layer and each of the first and second electrodes.

A vertical chemiresistor as described herein may be integrated sensor. By an “integrated” sensor as used herein is meant that at least one electrode and/or an organic semiconducting layer is common to the vertical chemiresistor and another sensor. Optionally, the other sensor is a horizontal chemiresistor or organic thin film transistor (OTFT).

Each sensor of the integrated sensor may be connected to apparatus for measuring a response of the sensor to an analyte. For example, in the case of an integrated vertical chemiresistor and OTFT, the vertical chemiresistor may be connected to apparatus for measuring resistance thereof and the OTFT may be connected to apparatus for measuring drain current thereof.

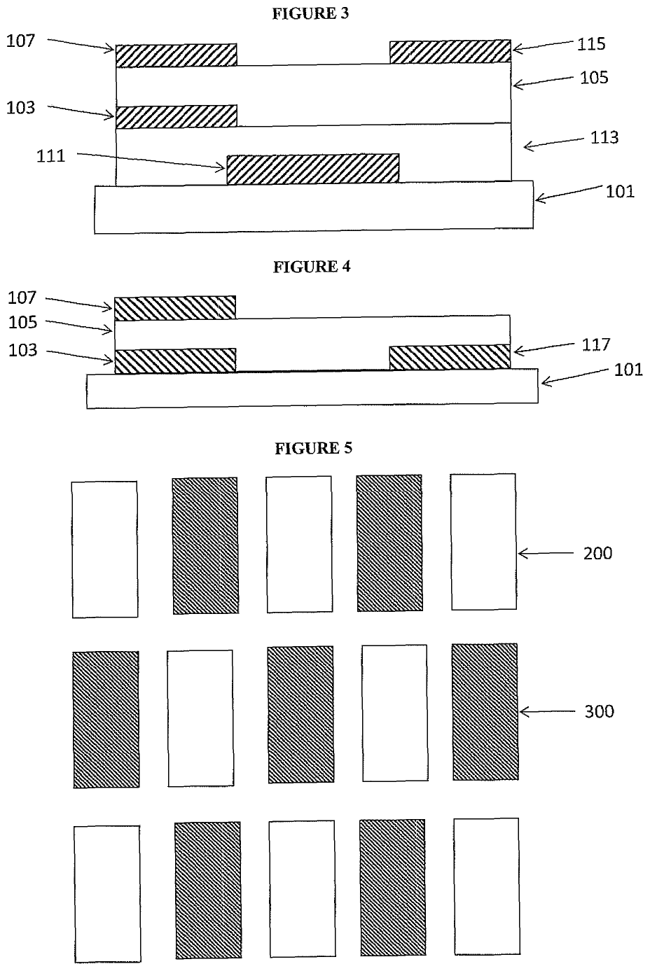

FIG. 3 illustrates an integrated vertical chemiresistor and OTFT. The OTFT comprises a gate electrode 111 over a substrate 101; source and drain electrodes 107, 115; and an organic semiconducting layer 105 between the dielectric layer and the source and drain electrodes. The device further comprises a first electrode 103 aligned vertically with the source electrode and separated therefrom by the organic semiconductor layer 105 such that the electrode 103 or 107 may function as both the source electrode of the OTFT and the second electrode of the chemiresistor.

FIG. 3 illustrates an integrated vertical chemiresistor comprising a bottom gate, top contact OTFT. In other embodiments, not shown, the OTFT may be a bottom gate, bottom contact device in which the source and drain electrodes line between the dielectric layer and the organic semiconducting layer and wherein the source and drain electrodes are at least partially covered by the source and drain electrodes. In these embodiments, the source electrode may also function as the first electrode of a chemiresistor in combination with a vertically aligned second electrode on an opposing surface of the organic semiconducting layer.

In other embodiments, not shown, an integrated vertical chemiresistor may comprise a top gate OTFT.

Different responses of the OTFT and the chemiresistor to different gases, for example different changes in drain current of the OTFT and/or different changes in resistance of the chemiresistor, may be used to differentiate between different gases in an environment that the device is exposed to.

FIG. 4 illustrates an integrated vertical chemiresistor and horizontal chemiresistor. The horizontal chemiresistor comprises electrodes 103, 107 horizontally separated and supported over substrate 101. An organic semiconducting layer 105 is between and in electrical connection with the electrodes. The device further comprises a second electrode 107 aligned vertically with the electrode 103 and separated therefrom by the organic semiconductor layer 105 such that the electrode 103 may function as both the first electrode of a vertical chemiresistor as described herein or, with electrode 117, as an electrode of the horizontal chemiresistor. The electrodes of a horizontal chemiresistor as described herein may be separated by a distance of between 5-500 microns, optionally 50-500 microns.

FIG. 4 illustrates an integrated sensor in which the horizontal chemiresistor is a bottom contact chemiresistor, i.e. a chemiresistor in which the organic semiconducting layer 105 at least partially covers the first and second electrodes. It will be appreciated that this device may be formed by forming the organic semiconducting layer over the first and second electrodes.

In another embodiment, an integrated sensor comprises a vertical chemiresistor and horizontal chemiresistor as described with reference to FIG. 4 in which the horizontal chemiresistor is a top contact chemiresistor, i.e. in which the organic semiconducting layer is between the substrate and the first and second electrodes. It will be appreciated that such a device may be formed by forming the first and second electrodes over the organic semiconducting layer.

A first chemiresistor and a second chemiresistor as described herein, wherein the first and a second chemiresistors are different and have different responses to a target gas or target gases, may be used in combination in a gas sensor system wherein different responses of the first chemiresistor and second chemiresistor may be used to differentiate between different gases in an environment. For example, a gas sensor system may comprise a first chemiresistor without a blocking layer and a second chemiresistor with a blocking layer.

FIG. 5, illustrates schematically a gas sensor system comprising a plurality of each of the first and second chemiresistors as described herein arranged in an array of alternating first and second sensors, however it will be appreciated that the first and second sensors may be provided in different first: second sensor ratios and/or in different configurations relative to one another. In some embodiments, the gas sensor system may comprise only one first sensor and/or only one second sensor.

A gas contacting an electrode surface, such as a gas having a dipole moment, may result in a change in work function at the electrode surface, for example as a result of binding of the gas to the electrode surface. Schottky current dependence on work function may mean that even a relatively small change in work function Δϕ has a large effect on currents J₁ and J₂ at these work functions:

J₂/J₁ =e⁻⁽^{^{Δϕ}}^{/}^{_{kT}}⁾

Use of first and second gas sensors with and without blocking layers as described herein may provide improved identification of a gas in an atmosphere and/or improved differentiation between different gases in an atmosphere, such as an atmosphere containing a gas with a dipole moment, such as 1-MCP and a gas without a dipole moment, such as ethylene.

In another embodiment, a gas sensor system may comprise first and second gas sensors having the same structure in which the effective work function of the first and second electrodes is different, for example a device in which a blocking layer is formed between only one of the first and second electrodes and the organic semiconducting layer. In use, one of forward and reverse bias is applied to the first gas sensor and the other of forward and reverse bias is applied to the second gas sensor. According to this embodiment, the different responses of the device to forward and reverse bias may allow for differentiation between changes arising due to absorption of a gas by the semiconducting layer and binding of a gas to an electrode.

The current of devices as described herein at a given voltage is suitably limited by the electrode-semiconductor contact resistance. The presence of a blocking layer on an electrode as described herein may limit an effect that a gas may have on the contact resistance between the electrode and the semiconducting layer.

Gas sensors and gas sensor systems as described herein are preferably for sensing an alkene, more preferably 1-methylcyclopropene (1-MCP) and/or ethylene, and most preferably used in an environment in which one or both of ethylene and 1-MCP may be present.

A gas sensor or gas sensor system as described herein may be used in an environment in which alkenes may be present in the environmental atmosphere, for example a warehouse in which harvested climacteric fruits and/or cut flowers are stored and in which ethylene may be generated.

If ethylene concentration reaches or exceeds a predetermined threshold value, which may be any value greater than 0, then 1-MCP may be released from a 1-MCP source to retard the effect of the ethylene, such as ripening of fruit or opening of flowers in the environment.

Optionally, 1-MCP may be released into the atmosphere if 1-MCP concentration falls to or below a threshold 1-MCP concentration value. The threshold 1-MCP concentration value may be 0 or a positive value.

1-MCP may be released automatically from a 1-MCP source or an alert or instruction may be generated to manually release 1-MCP from a 1-MCP source in response to signal from a gas sensor or gas sensor system as described herein upon determination that 1-MCP concentration is at or below a threshold that is a positive value and/or in response to a determination that ethylene concentration is at or exceeds a threshold which may be 0 or a positive value.

A gas sensor or gas sensor system as described herein may be in wired or wireless communication with a controller which controls automatic release of 1-MCP from a 1-MCP source and/or a user interface providing information on the presence and/or concentration of ethylene and/or 1-MCP in the environment.

An environment in which an alkene may be present may be divided into a plurality of regions if the concentration of an alkene or alkenes may differ between regions, each region comprising a gas sensor or gas sensor system as described herein and a source of 1-MCP. For example, a warehouse may comprise a plurality of regions.

The gas sensor system may comprise one or more control gas sensors, to provide a baseline taking into account variables such as one or more of humidity, temperature, pressure, variation of sensor parameter measurements over time (such as variation of OTFT sensor drain current over time), and gases other than a target gas or target gases in the atmosphere. One or more control gas sensors may be isolated from the atmosphere, for example by encapsulation of the or each control sensor, to provide a baseline measurement other than gases in the atmosphere.

The response of gas sensors as described herein to background gases other than the target gases for detection, for example air or water vapour, may be measured prior to use to allow subtraction of the background from measurements of a gas sensor when in use.

Each of the sensors of a gas sensor system may be supported on a common substrate and/or contained in a common housing.

In use, each sensor may be connected to a common power source, or two or more of the sensors may be powered by different sources

In use, power to all of the sensors of the gas sensor may be controlled by a single switch or power to two or more of the sensors may be controlled by different switches.

### Blocking Layer

A blocking layer, if present, is preferably a monolayer formed on a surface of the first and second electrodes. A blocking layer may be formed from a binding compound of formula (I):

R−X (1)

where, R is an organic residue and X is a binding group for binding to the surface of the source and drain electrodes. The binding group X may bind to the source and drain electrodes to form a self-assembled monolayer.

X may be selected according to the material of the source and drain electrodes. Preferably, X is a thiol or a silane group. A thiol group X is particularly preferred in the case where the first and second electrodes are gold.

Preferably, R is a C₁₋₃₀ hydrocarbyl group which may be unsubstituted or substituted with one or more substituents. Exemplary C₁₋₃₀ hydrocarbyl groups are: C₆₋₂₀ aromatic groups, preferably phenyl, phenyl with one or more C₁₋₂₀ alkyl groups; and phenyl-C₁₋₂₀ alkyl which may be substituted with one or more C₁₋₂₀ alkyl groups.

A preferred substituent of the C₁₋₃₀ hydrocarbyl group is fluorine, and one or more H atoms of the C₁₋₃₀ hydrocarbyl group may be replaced with fluorine.

Exemplary compounds of formula (I) are:

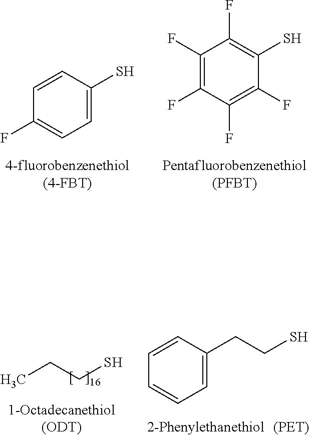

The blocking layer may alter the work function of the electrode or electrodes it is formed on.

The blocking layer may be selected according to the effect, if any, of the blocking layer on the work function of the first and/or second electrodes.

A monolayer may be formed on the first electrode, or on the first and second electrodes, by depositing the binding compound on the electrode or electrodes, for example from a solution of the binding compound in one or more solvents.

The binding compound may be selectively deposited onto the first and second electrodes only, or may be deposited by a non-selective process such as spin-coating or dip-coating.

### Semiconductor Layer

The invention has been described with reference to sensors comprising organic semiconductors, however it will be appreciated that an inorganic semiconductor may be used in place of an organic semiconductor as described anywhere herein.

Organic semiconductors as described herein may be selected from conjugated non-polymeric semiconductors; polymers comprising conjugated groups in a main chain or in a side group thereof; and carbon semiconductors such as graphene and carbon nanotubes.

An organic semiconductor layer as described herein may comprise or consist of a semiconducting polymer and/or a non-polymeric organic semiconductor. The organic semiconductor layer may comprise a blend of a non-polymeric organic semiconductor and a polymer. Exemplary organic semiconductors are disclosed in WO 2016/001095,the contents of which are incorporated herein by reference.

The organic semiconducting layer may be deposited by any suitable technique, including evaporation and deposition from a solution comprising or consisting of one or more organic semiconducting materials and at least one solvent. Exemplary solvents include benzenes with one or more alkyl substituents, preferably one or more C_{1—10} io alkyl substituents, such as toluene and xylene; tetralin; and chloroform. Solution deposition techniques include coating and printing methods, for example spin coating dip-coating, slot-die coating, ink jet printing, gravure printing, flexographic printing and screen printing.

Optionally, the organic semiconducting layer of an organic thin film transistor has a thickness in the range of about 10-200 nm.

Exemplary inorganic semiconductors include, without limitation, n-doped silicon; p-doped silicon; compound semiconductors, for example III-V semiconductors such as GaAs or

InGaAs; doped or undoped metal oxides; doped or undoped metal sulfides; doped or undoped metal selenides; or doped or undoped metal tellurides.

Gas sensors have been described herein with reference to 1-MCP and ethylene, however it will be appreciated that these sensors may be used in detection of strained alkenes generally, optionally compounds comprising a cyclopropene or cyclobutene group, of which alkylpropenes such as 1-MCP are examples; in detection of aliphatic alkenes, optionally ethylene, propene, 1-butene or 2-butene; and/or in detection of compounds with a dipole moment, such as hydrocarbons which do not have a mirror plane bisecting a carbon-carbon bond of the hydrocarbon. Preferably, compounds with a dipole moment as described herein have a dipole moment of greater than 0.2 Debyes optionally greater than 0.3 or 0.4 Debyes.

### EXAMPLES

### Device Example 1

Semiconducting Polymer 1 was deposited onto a first gold electrode having an area of about 6 mm² supported on a glass substrate spin-coating to form a 300 nm thick semiconducting layer covering the first electrode. A second gold electrode (4 mm×0.2 mm) was formed on the semiconducting layer by thermal evaporation, giving an overlap of about 1 mm² between the first and second electrodes. The first and second electrodes were connected to apparatus for application of a bias and for measuring the response of the chemiresistor on application of a bias.

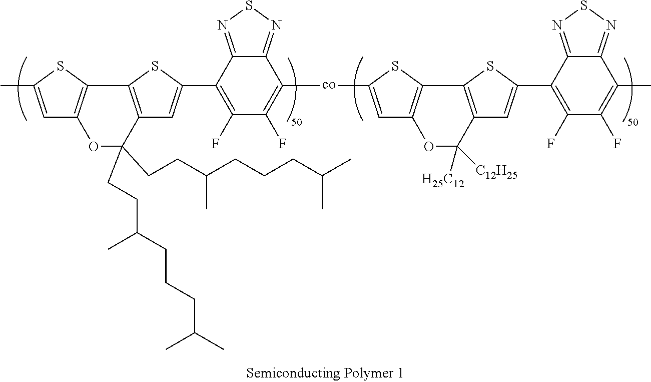

### Device Example 2

A device was prepared as described with reference to Device Example 1 except that a blocking layer was formed on the gold first electrode by immersing the substrate in a solution of 4-fluorobenzenethiol in isopropyl alcohol (0.14 μL/ml) for a period of 2 minutes. The solution was then removed by spinning the substrate and rinsed with IPA to remove excess thiol and the substrate was dried at 60° C. for 10 minutes

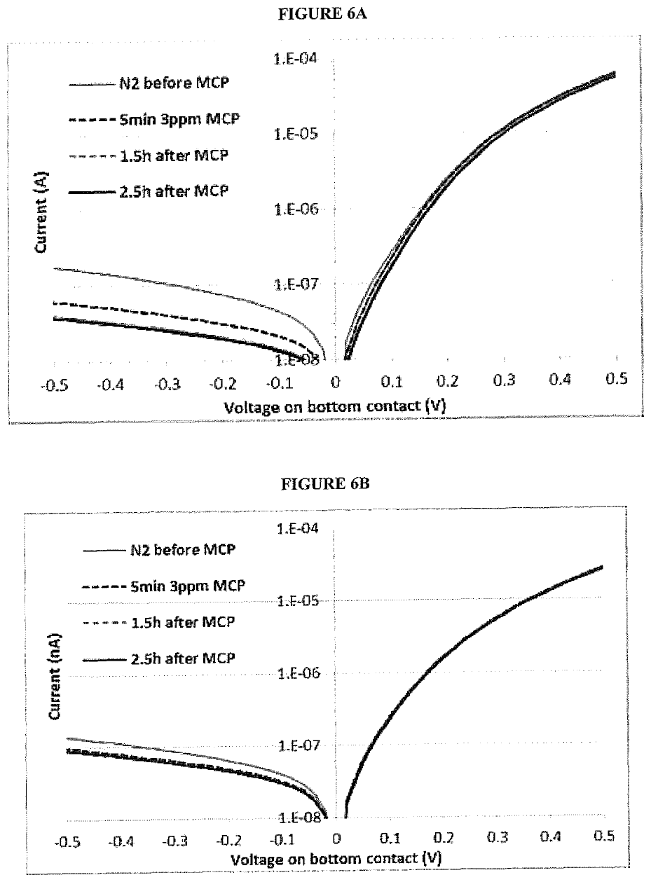

FIG. 6A and 6B are, respectively, graphs of current vs. voltage applied to the bottom (first) electrode of Device Examples 1 and 2 following exposure of the devices to an environment of 3 ppm of 1-MCP in nitrogen gas for 5 minutes, 1.5 hours and 2.5 hours. With reference to FIG. 6A, the response is different for negative and positive voltages applied to the bottom electrode in the presence of nitrogen only. Without being bound by any theory, this may be due to the presence of an oxide layer on the surface of the bottom electrode, and the reduction in current at negative voltage upon exposure to 1-MCP is attributed to an effect of the 1-MCP on the top electrode/organic semiconductor interface.

Little or no change was observed following removal of 1-MCP from the environment, suggesting that 1-MCP binds strongly to a surface of the device or otherwise becomes trapped in the device.

With reference to FIG. 6B, the response to 1-MCP of Device Example 1 is significantly larger than that of Device Example 2, particularly at negative bias.

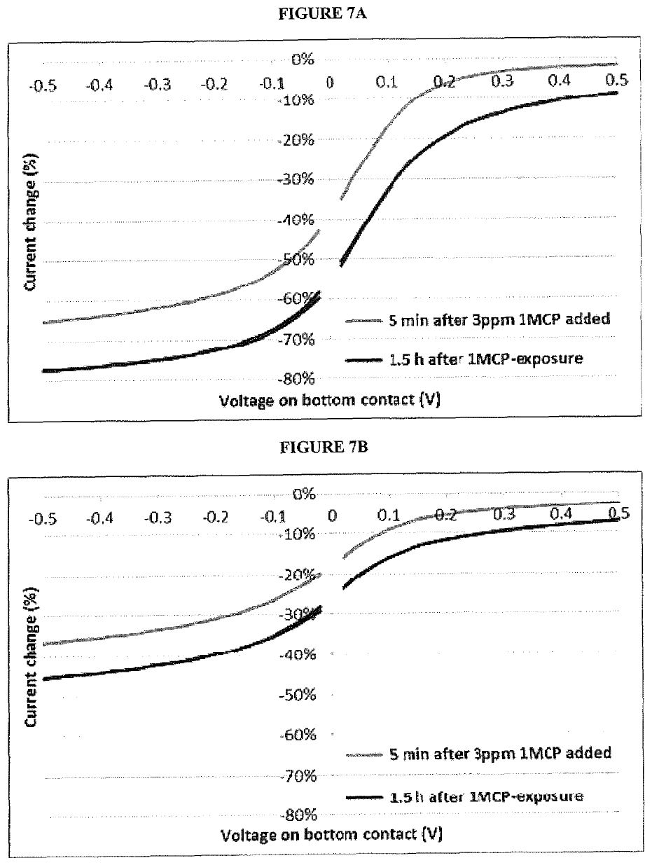

FIGS. 7A and 7B illustrate a change in current of Device Examples 1 and 2 respectively after 5 minutes and 1.5 hours exposure to 3 ppm of 1-MCP. The change for Device Example 2 is considerably larger.

Without wishing to be bound by any theory, the thiol-treated electrode of Device Example 2 may reduce the ability of 1-MCP to bind to the electrode.

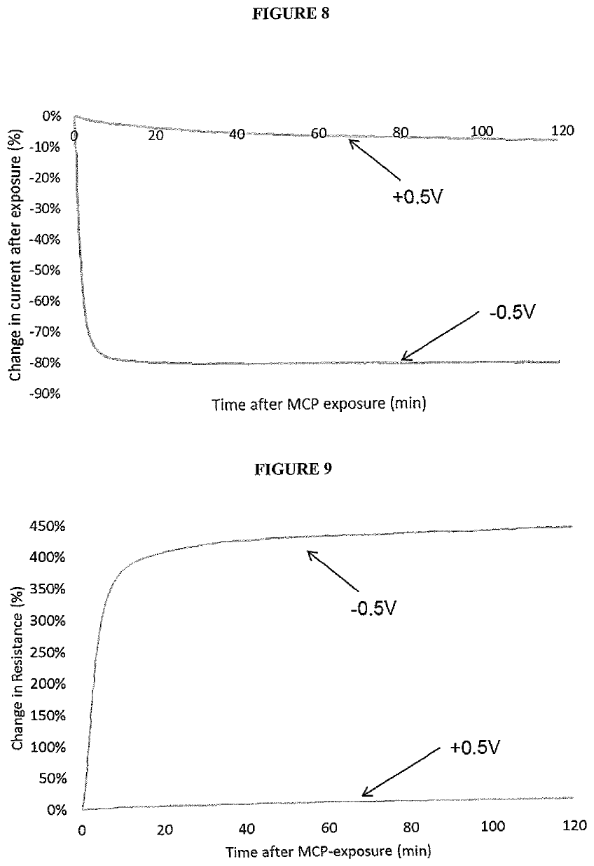

As shown in FIGS. 8 and 9, a sharp fall in current at constant voltage and a corresponding sharp rise in resistance is observed upon exposure of Device Example 1 to 1-MCP at negative bias.

Although the present invention has been described in terms of specific exemplary embodiments, it will be appreciated that various modifications, alterations and/or combinations of features disclosed herein will be apparent to those skilled in the art without departing from the scope of the invention as set forth in the following claims.

1. A gas sensor comprising:
a first vertical chemiresistor comprising a bottom electrode supported on a substrate, a top electrode and an organic semiconducting layer disposed between the bottom and top electrodes, wherein the bottom electrode and organic semiconducting layer are positioned between the top electrode and the substrate; and
a potential difference controller configured to apply a first potential difference and a second potential difference to the first vertical chemiresistor, wherein the first potential difference has a first polarity and the second potential difference has a second polarity and the first polarity is opposite to the second polarity, wherein the gas sensor is configured for detecting and/or measuring a first gas in an environment containing a second gas, wherein at least one of the first gas and second gas comprises an alkene.

2. A gas sensor according to claim 1, further comprising:
a processor configured to process a presence and/or a concentration of the first gas from a first current flowing through the first vertical chemiresistor when the first potential difference is applied to the first vertical chemiresistor and a second current flowing through the first vertical chemiresistor when the second potential difference is applied to the first vertical chemiresistor.

3. (canceled)

4. A gas sensor according to claim 1, wherein the first and second gases comprise an alkene.

5. A gas sensor according to claim 1, wherein the first gas comprises 1-methylcyclopropene and the second gas comprises ethylene.

6. A gas sensor according to claim 1, wherein at least one of the bottom and top electrodes is configured to provide that a work function of the at least one of the bottom and top electrodes changes when contacted by the first gas.

7. A gas sensor according to claim 6, wherein the contact resistance of the at least one of the bottom and top electrodes does not change when contacted by the second gas.

8. A gas sensor according to claim 1, wherein a bulk resistance of the semiconductor layer changes when the semiconductor layer is contact with the second gas.

9. A gas sensor according to claim 1, wherein at least one of the bottom and top electrodes comprises or consists of gold.

10. A gas sensor according to claim 1, wherein the first vertical chemiresistor comprises a blocking layer between at least one of the bottom and top electrodes and the organic semiconducting layer.

11. A gas sensor according to claim 10, wherein the blocking layer is a monolayer on a surface of at least one of the bottom and top electrodes.

12. A gas sensor according to claim 11, wherein the monolayer comprises a thiol group bound to the surface of at least one of the bottom and top electrodes.

13. A gas sensor according to claim 1, wherein the semiconductor layer is in direct contact with the blocking layer.

14-15. (canceled)

16. A method of detecting a first gas in an environment containing a second gas, comprising:
measuring a first response of a first vertical chemiresistor to the gaseous environment; and
determining from the first response a presence of the first gas, wherein the first vertical chemiresistor comprises a bottom electrode supported on a substrate, a top electrode and a semiconducting layer disposed between the top and bottom electrodes, and wherein at least one of the top and bottom electrodes comprises a material with a work function that changes when contacted with the first gas and is unchanged when contacted with the second gas.

17. A method of detecting a first gas according to claim 16, wherein the first and the second gas comprise an alkene.

18. A method of detecting a first gas according to claim 16, wherein the first gas comprises 1-methylcyclopropene.

19. A method of detecting a first gas according to claim 16, wherein the second gas comprises ethylene.

20. A method of detecting a first gas according to claim 16, wherein a bulk resistivity of the semiconducting layer changes in a presence of the second gas.

21. A method of detecting a first gas according to claim 20, wherein changes to the bulk resistivity of the semiconducting layer are used to determine a presence and/or a concentration of the second gas.

22. A method of detecting a first gas according to claim 20, further comprising:
measuring a second response of a second vertical chemiresistor to the gaseous environment, wherein the second vertical chemiresistor comprises a bottom electrode supported on a substrate, a top electrode and a semiconducting layer disposed between the top and bottom electrodes, and
wherein at least one of the top and bottom electrodes is separated from the semiconducting layer by a blocking layer and determining from the first response the presence of the first gas comprises determining from the first and the second response.

23. A method of detecting a first gas according to claim 16, wherein measuring the first response of the first vertical chemiresistor to the gaseous environment comprises applying a first potential to the first vertical chemiresistor and measuring a first current and applying a second potential to the first vertical chemiresistor and measuring a second current wherein the first and the second potentials have an opposite polarity.
